(19) United States
(12) Patent Application Publication
(10) Pub. No.: US 2012/0305531 A1
(43) Pub. Date: Dec. 6, 2012

(54) Automatic Welding Method

(76) Inventors: Chi-Wah Keong, Kaohsiung City (TW); Lung-Tien Wu, Kaohsiung City (TW); Wei- Ren Chiang, Kaohsiung City (TW); Chih-Lun Lin, Kaohsiung City (TW)

(21) Appl. No.: 13/339,535

(22) Filed: Dec. 29, 2011

(30) Foreign Application Priority Data
May 31, 2011 (TW) 100119113

(51) Int. Cl. B23K 25/00

(52) U.S. Cl. 219/73

(57) ABSTRACT

An automatic welding method includes a preliminary step and a joining step. The preliminary step is configured to place a metal object having a multi-dimensional curved weld zone on a platform, and to clamp a welding torch with a welding torch clamping device. The joining step is configured to generate a relative movement between a tip of the welding torch and the multi-dimensional curved weld zone of the metal object, and to electrify the welding torch to weld the metal object by way of short circuiting arc transfer. An angle difference between a reference position and an instant position of the welding torch is 0 to 135 degrees when the welding torch welds the metal object, so as to keep the slag from spraying, wherein the welding torch is at the reference position when the tip thereof is pointed straight down towards the ground.

### BACKGROUND OF THE INVENTION

1. Field of the Invention

The present invention generally relates to an automatic welding method and, more particularly, to an automatic welding method that can be applied to a metal object with three-dimensional curved weld zone.

2. Description of the Related Art

Welding methods are widely adopted in a variety of fields. Different welding method is chosen based on the attribute of a metal object to be welded, so as to obtain high quality welding effect on the surface of the metal object.

Take the bicycle industry as an example, most of high-price bicycles use aluminum alloy to manufacture components such as a bicycle fork or a bicycle frame. Since it is required to form high quality weld zones having fish scale patterns on the bicycle fork and the bicycle frame, artificial TIG welding technique is still used to provide this advantage. However, the TIG welding technique can only be applied to welding of the same category of metals. Further, the welding material usually does not penetrate the weld zones evenly; therefore, other metal component is mixed into the weld zones. In a worse case, the weld zones may distort because the heat affected zone becomes wider. Since the welding torch is independent from the welding material in the TIG welding technique, it is more difficult to perform the TIG welding technique. Thus, welders have to be trained in a long time to be able to form fish scale patterns on the surface of the weld zones. Moreover, welding techniques are going the way of automation due to shortage of human labor. However, automation of the TIG welding technique is never able to be accomplished due to the complex procedures of the TIG welding technique, resulting in a huge impact on modern bicycle industry.

In light of this, many bicycle manufacturers have used different welding techniques to replace the conventional one in attempt to overcome the problem of human labor shortage through adoption of automatic welding methods while producing high quality weld zones having fish scale patterns.

Conventional welding techniques such as Metal Inert-Gas welding (MIG) or Cold Metal Transfer (CMT) are welding methods that can be performed using a single hand and are used to manipulate a welding torch having welding material disposed therein. The welding techniques do overcome the problem of inconvenient welding operation and realize automation of production lines, eliminating the industrial impact resulted from shortage of human labor.

However, the conventional MIG welding technique is a welding process of spray arc transfer which produces a significant amount of spraying slag after welding, resulting in a poor welding quality and an appearance defect of the bicycle. This takes a significant amount of time to clean the spraying slag without obtaining desired high quality weld zones having fish scale patterns. In a worse case, the weld zones may distort because a significant amount of heat energy is consumed during welding process of the spray arc transfer. As a result, the MIG welding technique is never able to be efficiently applied to welding of bicycles.

The problem of spraying slag no longer exists when the CMT welding technique is applied to weld the bottom of a car. When welding a bicycle, although the CMT welding technique is able to produce high quality weld zones having fish scale patterns via short circuiting arc transfer, the CMT welding technique still produces a significant amount of spraying slag when applied to complex three-dimensional (3D) curved weld zone of the bicycle. Therefore, it is required to provide an additional procedure to clean the spraying slag so that the high quality weld zones having fish scale patterns can be clearly shown, maintaining better appearance quality of the bicycle fork and the bicycle frame.

In light of this, a need exists to provide an automatic welding method that can perform welding process automatically and can overcome the above problems when applied to a metal object with 3D curved weld zone.

### SUMMARY OF THE INVENTION

It is therefore the primary objective of this invention to provide an automatic welding method that can form high quality fish scale patterns on weld zone by avoiding slag spraying.

It is another objective of this invention to provide an automatic welding method that can reduce the heat energy consumed during welding process to prevent the weld zone from distorting.

It is yet another objective of this invention to provide an automatic welding method that can be developed to construct automatic production lines, thereby eliminating the industrial impact resulted from human labor shortage.

The invention discloses an automatic welding method comprising a preliminary step and a joining step. The preliminary step is configured to place a metal object having a multi-dimensional curved weld zone on a platform, and to clamp a welding torch with a welding torch clamping device. The joining step is configured to generate a relative movement between a tip of the welding torch and the multi-dimensional curved weld zone of the metal object, and to electrify the welding torch in order for the welding torch to weld the metal object by way of short circuiting arc transfer, allowing fish scale patterns to be formed on the multi-dimensional curved weld zone of the metal object. An angle difference between a reference position and an instant position of the welding torch is 0 to 135 degrees when the welding torch welds the metal object, so as to keep the slag from spraying, wherein the welding torch is at the reference position when the tip thereof is pointed straight down towards the ground.

Furthermore, the invention discloses an automatic welding method comprising a preliminary step and a joining step. The preliminary step is configured to place a metal object having multi-dimensional curved weld zone on a platform, and to clamp a welding torch with a welding torch clamping device. The joining step is configured to manipulate the welding torch clamping device to move the tip of the welding torch along the multi-dimensional curved weld zone of the metal object within a pivot range, and to electrify the welding torch in order for the welding torch to weld the metal object by way of short circuiting arc transfer for forming fish scale patterns on the multi-dimensional curved weld zone of the metal object. The pivot range represents an angle difference between a reference position and an instant position of the welding torch when the tip of the welding torch is being moved along the multi-dimensional curved weld zone of the metal object, wherein the welding torch is at the reference position when the tip thereof is pointed straight down towards the ground. The pivot range is 0 to 135 degrees.

Furthermore, the invention discloses an automatic welding method comprising a preliminary step and a joining step. The preliminary step is configured to place a metal object having multi-dimensional curved weld zone on a movable platform, and to clamp a welding torch with a welding torch clamping device within a setup range. The joining step is configured to move the metal object with respect to the welding torch through the movable platform such that the tip of the welding torch is moved relatively to the multi-dimensional curved weld zone for welding operation, and to electrify the welding torch in order for the welding torch to weld the metal object by way of short circuiting arc transfer for forming fish scale patterns on the multi-dimensional curved weld zone of the metal object. The setup range represents an angle difference between a reference position and an instant position of the welding torch, wherein the welding torch is at the reference position when the tip thereof is pointed straight down towards the ground. The angle difference is 0 to 135 degrees.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an automatic welding machine utilized by the invention.

FIG. 2 shows a flowchart of an automatic welding method according to a first embodiment of the invention.

FIG. 3 shows an operation diagram of short circuiting arc transfer according to the first embodiment of the invention.

FIGS. 4a to 4d show operation diagrams of the first embodiment of the invention.

FIG. 5 shows a flowchart of an automatic welding method according to a second embodiment of the invention.

FIG. 6 shows an operation diagram according to the second embodiment of the invention.

FIG. 7 shows a bicycle fork and a bicycle frame having weld zones with fish scale patterns.

FIG. 8 shows metallographic analysis diagrams of the bicycle fork and the bicycle frame.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

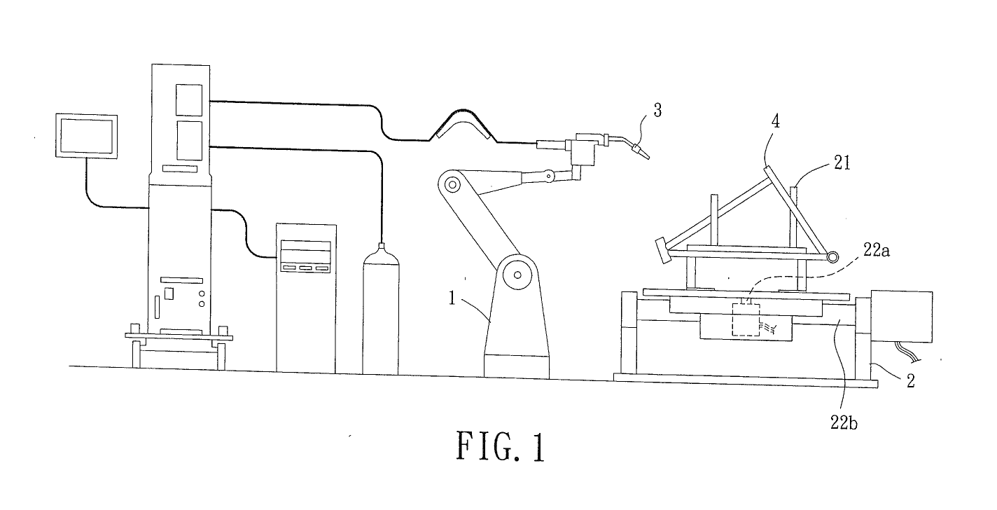

FIG. 1 shows an automatic welding machine comprising a welding torch clamping device 1 and a platform 2. The welding torch clamping device 1 is provided to clamp a welding torch 3. The welding torch clamping device 1 may be a movable robotic arm or an immovable robotic arm, but is not limited thereto. There is a clamping device 21 on the platform 2 that clamps a metal object 4 to be welded, allowing the welding torch 3 to proceed welding of the metal object 4 by way of short circuiting arc transfer. Furthermore, the platform 2 may include a shaft 22a that can turn the platform 2 in a horizontal direction, as well as a shaft 22b that can turn the platform 2 in a vertical direction. The automatic welding machine of the invention is briefly described herein, and detailed description thereof will be made with an automatic welding method below. The detailed structure of the proposed automatic welding machine is not described herein as it can be readily appreciated by one skilled in the art. However, the structure of the automatic welding machine is not limited to what is disclosed in the application.

The automatic welding method of the invention is operated on the automatic welding machine, comprising a preliminary step S1 and a joining step S2. The preliminary step S1 is configured to place a metal object 4 having multi-dimensional curved weld zone on a platform 2, and to clamp a welding torch 3 with a welding torch clamping device 1. The joining step S2 is configured to move a tip of the welding torch 3 along the multi-dimensional curved weld zone of the metal object 4, and to electrify the welding torch 3 in order for the welding torch 3 to weld the metal object 4 by way of short circuiting arc transfer, allowing fish scale patterns to be formed on the multi-dimensional curved weld zone of the metal object 4. When the welding torch 3 is being manipulated during welding process, the welding torch 3 may be moved from a reference position by an angle of 0 to 135 degrees to keep the slag from spraying, wherein the welding torch 3 is at the reference position when the tip thereof is pointed straight down towards the ground.

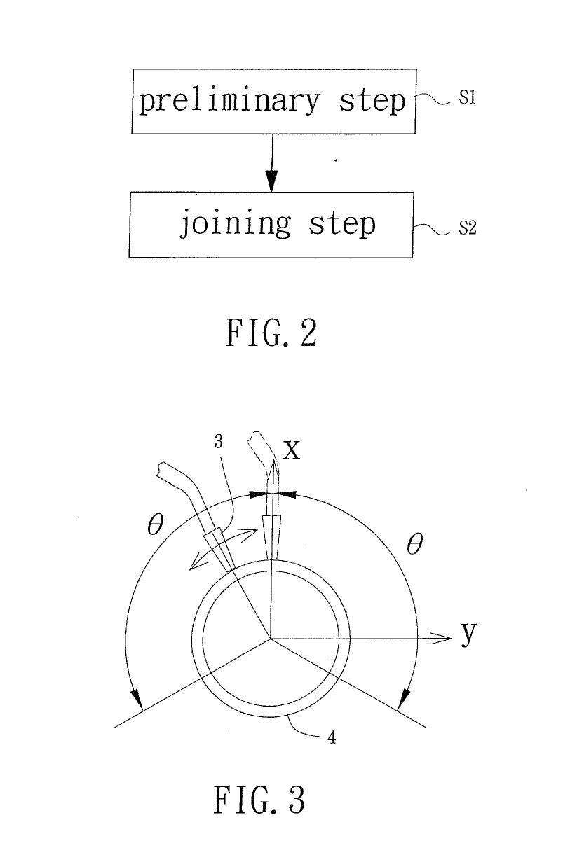

FIG. 2 shows a flowchart of an automatic welding method operated on the proposed automatic welding machine according to a first embodiment of the invention. The automatic welding method comprises a preliminary step S1 and a joining step S2. The automatic welding machine preferably consists of a welding torch clamping device 1 and a platform 2, with the welding torch clamping device 1 equipped with a welding torch 3. In such an arrangement, the automatic welding machine can be used to weld a metal object 4 having multi-dimensional curved weld zone by way of short circuiting arc transfer. In this embodiment, the welding torch clamping device 1 may be a movable robotic arm capable of driving the welding torch 3 to move around the metal object 4 for welding operation. The multi-dimensional curved weld zone of the metal object 4 may be in the form of a curved line, a closed curved line, a 2D curved weld zone or a 3D curved weld zone. The metal object 4 having 3D curved weld zone will be described below for illustration purpose.

Referring to FIGS. 1 and 2, the preliminary step S1 is configured to place the metal object 4 with 3D curved weld zone on the platform 2, and to clamp the welding torch 3 with the welding torch clamping device 1. The platform 2 in the embodiment is preferably an immovable platform which securely fixes the metal object 4 using the clamping device 21 thereof. The metal object 4 may be vertically or horizontally fixed on the platform 2, allowing the portions of the metal object 4 to be welded to face the tip of the welding torch 3. For example, bicycle structure such as the bicycle fork or the bicycle frame is welded in this embodiment for illustration purpose, so as to form high quality fish scale patterns on the multi-dimensional curved weld zone of the bicycle fork or the bicycle frame.

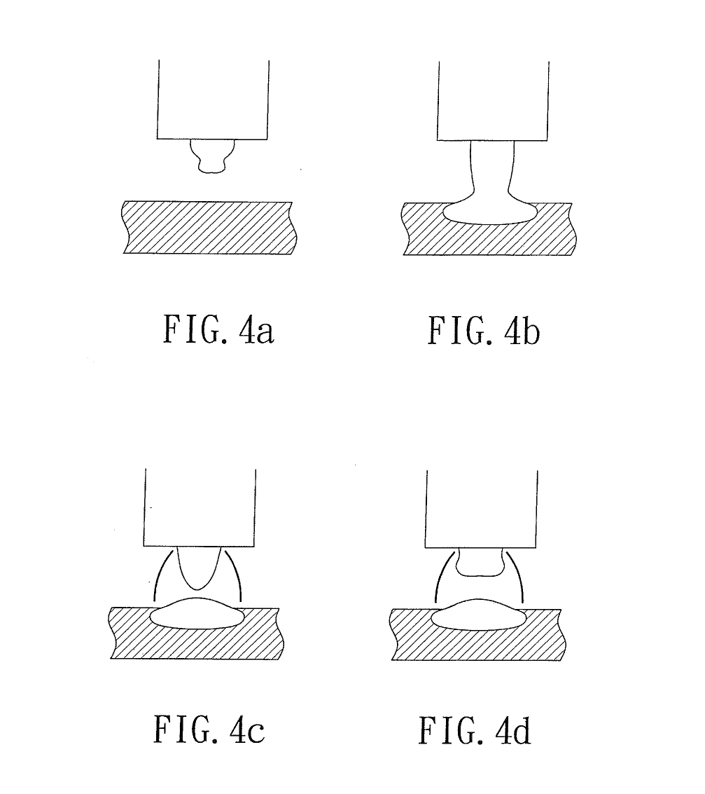

The joining step S2 is configured to manipulate the movable robotic arm (by which the welding torch 3 is clamped) to move the tip of the welding torch 3 along the multi-dimensional curved weld zone of the metal object 4 within a pivot range, and to electrify the welding torch 3 for welding the metal object 4 by way of short circuiting arc transfer in order to form fish scale patterns on the 3D curved weld zone of the metal object 4. The pivot range of the welding torch 3 referred herein represents an angle difference between a reference position (such as an X axis shown in FIG. 3) and an instant position of the welding torch 3 when the tip of the welding torch 3 is moved along the 3D curved weld zone of the metal object 4 for welding the metal object 4, wherein the welding torch 3 is at the reference position when the tip thereof is pointed straight down towards the ground. The pivot range is 0 to 135 degrees. Specifically, referring to both FIGS. 1 and 3, the movable robotic arm 1 may manipulate the welding torch 3 to move the welding torch 3 along the 3D curved weld zone of the metal object 4 from a weld location of the metal object 4 to somewhere on the 3D curved weld zone of the metal object 4. The welding torch 3 may be moved leftwards or rightwards during movement (note the welding torch 3 is shown to be moved leftwards or rightwards in FIG. 3; however, the movement direction of the welding torch 3 is not limited thereto). The angle between the welding torch 3 and the reference position (X axis) is 0 to 135 degrees. In FIG. 3, an angle denoted as 9 is the pivot range mentioned in this embodiment. The welding torch 3 can proceed welding anywhere on the 3D curved weld zone of the metal object 4 within the pivot range. The metal object 4 is preferably welded by way of short circuiting arc transfer in order to produce high quality weld zone having fish scale patterns on the metal object 4. Referring to FIGS. 4a to 4d, under controlling of an output current, the short circuiting arc transfer forms droplets at the tip of the welding torch 3 by arc discharging and then shutdowns the output current to cause a short circuit at the tip of the welding torch 3, causing the droplets to drop as the welding torch 3 is withdrawn, thereby avoiding potential slag spraying during the welding process.

For instance, the short circuiting arc transfer may include the following procedures. Referring to FIG. 4a, the welding torch 3 is electrified with a current of 80 to 150 A to heat the tip of the welding torch 3 to cause a discharging of arc. Thus, the droplets are generated during forward movement of the welding torch 3 based on the rule of wire-feeding movement. Referring to FIGS. 4b and 4c, the tip of the welding torch 3 is instantly short-circuited once the droplets contact the weld location of the metal object 4, causing the arc to disappear. In this moment, a tightening effect occurs at the tip of the welding torch 3, causing the droplets to drop on the weld location of the metal object 4 under reaction of a surface tension generated by the withdrawal movement of the welding torch 3. Referring to FIGS. 4c and 4d, the tip of the welding torch 3 is re-heated to cause arc discharging again, which restarts the welding process. In this mechanism, the input current is almost zero when the droplets are being generated via short circuiting arc transfer, so that the droplets provide almost no heat to the weld location of the metal object 4. Therefore, the temperature pattern is “hot-cold-hot” (an alternating manner) during the welding operation, which significantly reduces the heat energy consumed during the welding operation while keeping the slag from spraying.

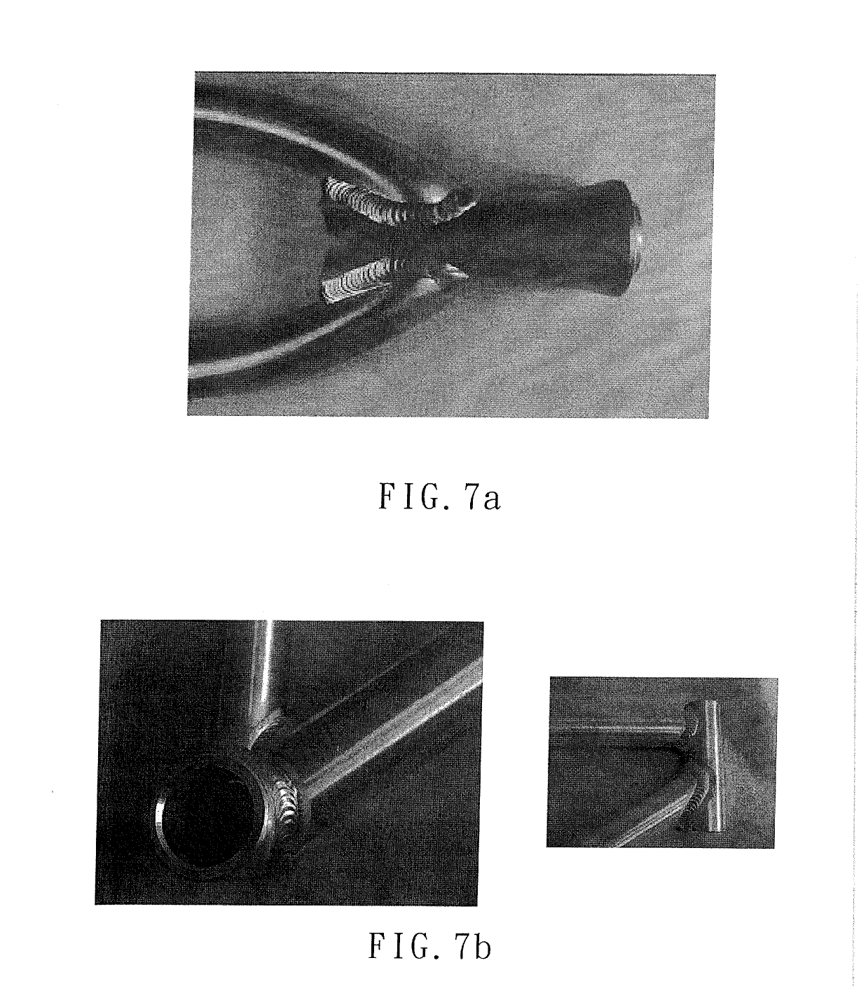

Note the welding torch 3 has been approached to and withdrawn from the weld location of the metal object 4 back and forth in a frequency as high as 70 times. Further, the speed of the to-and-fro movement of the welding torch 3 can be even controlled by a wire-feeding machine to speed up the whole welding process, providing fine, even, stable droplets to form high quality fish scale patterns on the 3D curved weld zone of the metal object 4 while preventing slag from spraying. As shown in FIG. 7, the 3D curved weld zones of a bicycle fork FIG. 7(a) and a bicycle frame FIG. 7(b) are shown to have slag-free fish scale patterns after the bicycle fork or the bicycle frame is welded using the proposed automatic welding method.

It can be known from the above description that droplets can be generated on the weld location of the metal object 4 under a small current via short circuiting arc transfer while distortion of the weld zone of the metal object 4 can be avoided because the input heat is in a small amount. Further, stable arc may be generated at the tip of the welding torch 3 based on the characteristics that the welding current is not affected by the speed of the wire-feeding movement. Breaking of arc will not happen even under frequent welding operations, providing a constant fusion depth to produce consistent high quality weld zone having fish scale patterns. Moreover, relative position of the welding torch 3 with respect to the weld location of the metal object 4 can be ensured when the welding torch 3 is manipulated by the movable robotic arm 1 to move within the pivot range, stabilizing the wire-feeding movement of the welding torch 3. This allows the droplets to be dropped anywhere on the metal object 4 without causing the slag to spray as the welding torch 3 moves back and forth, thereby improving the overall welding quality and avoiding spending time on cleaning the sprayed slag.

Furthermore, the immovable platform may be replaced with a movable platform 2 capable of being turned in both horizontal and vertical directions, allowing the metal object 4 to be turned in any manner by the movable platform 2 supporting the metal object 4. This ensures that the weld location of the metal object 4 will fall within the pivot range of the welding torch 3, attaining better turning control of the metal object 4. Therefore, the welding quality of the metal object 4 is improved, forming high quality fish scale patterns on the 3D curved weld zone of the metal object 4. In the first embodiment shown in FIG. 1, the movable platform 2 is turned by two shafts 22a and 22b. Specifically, the movable platform 2 is turned in the horizontal and vertical directions by the shaft 22a and 22b, respectively.

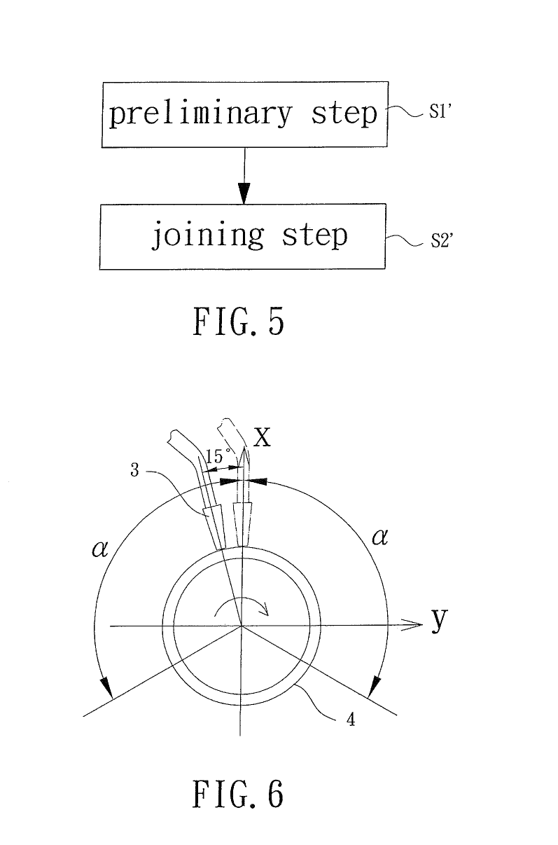

Referring to FIG. 5, an automatic welding method is disclosed according to a second embodiment of the invention. The automatic welding method is also operated on the automatic welding machine mentioned previously and comprises a preliminary step S1′ and a joining step S2′. The automatic welding machine consists of an immovable robotic arm 1 and a movable platform 2, and is used with a metal object 4 having 3D curved weld zone. In such an arrangement, the welding torch 3 can weld the metal object 4 via short circuiting arc transfer.

The preliminary step S1′ is configured to place the metal object 4 on the movable platform 2, and to clamp the welding torch 3 with the immovable robotic arm 1 within a setup range. Specifically, the metal object 4 can be horizontally or vertically fixed on the movable platform 2 as described in the previous embodiment, wherein the clamping device 21 may be provided to better clamp the metal object 4. The embodiment differs from the previous embodiment in that the platform 2 is movable.

The joining step S2′ is configured to move the metal object 4 with respect to the welding torch 3 through the movable platform 2 to allow the tip of the welding torch 3 to move relatively to the 3D curved weld zone, and to electrify the welding torch 3 for welding the metal object 4 by way of short circuiting arc transfer in order to produce fish scale patterns on the 3D curved weld zone of the metal object 4. In the joining step S2′, the welding torch 3 preferably welds the metal object 4 by way of short circuiting arc transfer within the setup range of the welding torch 3, wherein the setup range represents an angle difference between the reference position (e.g. an X axis shown in FIG. 6) and an instant position of the welding torch 3 clamped by the immovable robotic arm 1. The welding torch 3 is at the reference position when the tip thereof is pointed straight down towards the ground. The setup range of the welding torch 3 is 0 to 135 degrees. Specifically, referring to FIGS. 1 and 6, the metal object 4 is placed on the movable platform 2 and the welding torch 3 is clamped by the immovable robotic arm 1. Preferably, the 3D curved weld zone of the metal object 4 is adjusted in a position facing the tip of the welding torch 3. In this embodiment, the welding torch 3 is clamped above the metal object 4. After the metal object 4 is placed on the movable platform 2, the metal object 4 is driven by the movable platform 2 so that the 3D curved weld zone of the metal object 4 can move relatively to the tip of the welding torch 3 for welding operation. The welding torch 3 can be moved leftwards or rightwards from the reference position by 0 to 135 degrees to define the setup range. The setup range is indicated by the symbol a as shown in FIG. 6, allowing the weld location of the metal object 4 to face the tip of the welding torch 3 under turning of the movable platform 2. As such, the welding torch 3 may proceed welding anywhere on the 3D curved weld zone of the metal object 4. As an example, the welding torch 3 is on the left of the reference position in this embodiment, with a pivot angle of 15 degrees existing between the welding torch 3 and the reference position. Then, the movable platform 2 adjusts the weld location of the metal object 4 in a direction facing the tip of the welding torch 3 via the shafts 22a and 22b to attain better welding quality. Similar to the previous embodiment, the shafts 22a and 22b are arranged in the same manner, and the metal object 4 is welded by way of short circuiting arc transfer. Since the embodiment is similar to the previous embodiment, they are not described herein again for brevity.

In such an arrangement, even though the welding torch 3 clamped by the immovable robotic arm 1 cannot move as desired, the movable platform 2 may be moved to allow the weld location of the metal object 4 to face the tip of the welding torch 3. Thus, the welding torch 3 can weld the metal object 4 by way of short circuiting arc transfer without causing the slag to spray due to an improper angle of the welding torch 3. Moreover, high quality fish scale patterns may be formed on the 3D curved weld zone of the metal object 4 while the amount of heat energy consumed during the welding operation is reduced using short circuiting arc transfer to keep the weld zone of the metal object 4 from distorting.

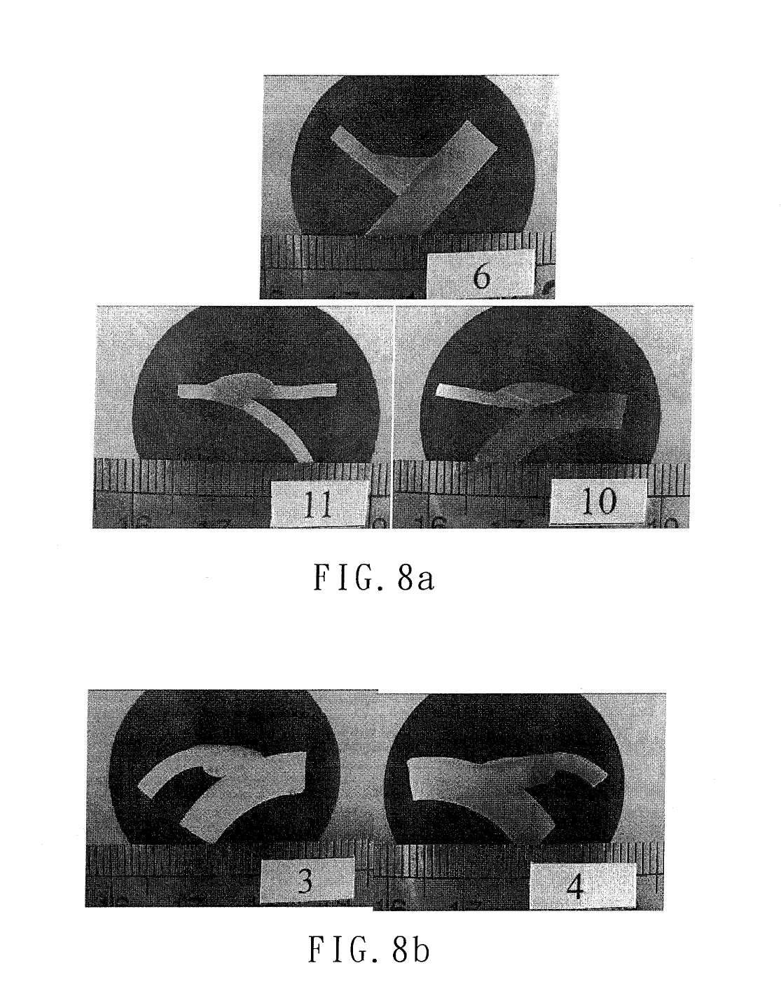

As shown in FIG. 8, metallographic analysis is performed on the bicycle fork FIG. 8(a) and the bicycle frame FIG. 8(b) to prove the automatic welding method of the invention as being advantageous in producing high quality fish scale patterns on the 3D curved weld zone of the metal object 4 without causing slag to spray by adjusting the position of the welding torch 3 or the metal object 4 via the movable robotic arm 1 or the movable platform 2. In the FIG. 8, it is clearly shown that all weld locations have full penetration without any blow hole or slag inclusion. Thus, it is proven that the proposed automatic welding method can form high quality fish scale patterns on weld zone.

Furthermore, a fatigue test is applied to the bicycle frame and the bicycle fork after welding operation. The result shows that the bicycle frame has a fatigue load of 122.4 kg and a fatigue life of more than 60,000 times, and the bicycle fork has a fatigue load of 66.4 kg and a fatigue life of more than 265,031 times, which is higher than the required commercial standard of an EN14766 mountain bike by 20 to 165%. Thus, it is proven that the proposed automatic welding method can obtain high welding strength, leading to a high quality welding process of the bicycle industry.

The automatic welding method of the invention can provide high quality weld zone having fish scale patterns while avoiding slag spraying, thereby improving the welding technique of bicycle frame/fork.

The automatic welding method of the invention can reduced the heat energy consumed during the welding process, thereby avoiding the weld zone from distorting.

The automatic welding method of the invention can be developed to construct automatic assembly lines to overcome the problem of human labor shortage, thereby improving the industrial automation.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. An automatic welding method, comprising:
a preliminary step placing a metal object with a multi-dimensional curved weld zone on a platform, and clamping a welding torch with a welding torch clamping device; and
a joining step generating a relative movement between a tip of the welding torch and the multi-dimensional curved weld zone of the metal object, and electrifying the welding torch in order for the welding torch to weld the metal object by way of short circuiting arc transfer, allowing fish scale patterns to be formed on the multi-dimensional curved weld zone of the metal object;
wherein an angle difference between a reference position and an instant position of the welding torch is 0 to 135 degrees when the welding torch welds the metal object, so as to keep the slag from spraying, wherein the welding torch is at the reference position when the tip thereof is pointed straight down towards the ground.

2. The automatic welding method as claimed in claim 1, wherein the platform is a movable platform or an immovable platform.

3. The automatic welding method as claimed in claim 1, wherein the welding torch clamping device is a movable robotic arm or an immovable robotic arm.

4. The automatic welding method as claimed in claim 1, wherein the metal object is a bicycle component.

5. The automatic welding method as claimed in claim 1, wherein the joining step manipulates the welding torch clamping device to move the tip of the welding torch along the multi-dimensional curved weld zone of the metal object within a pivot range, the pivot range represents an angle difference between a reference position and an instant position of the welding torch when the tip of the welding torch is moved along the multi-dimensional curved weld zone of the metal object, wherein the welding torch is at the reference position when the tip thereof is pointed straight down towards the ground, and the pivot range is 0 to 135 degrees.

6. The automatic welding method as claimed in claim 1, wherein the platform is movable, the preliminary step clamps the welding torch with the welding torch clamping device within a setup range, the joining step moves the metal object with respect to the welding torch through the movable platform to allow the tip of the welding torch to move relatively to the multi-dimensional curved weld zone for welding operation, the setup range represents an angle difference between a reference position and an instant position of the welding torch, wherein the welding torch is at the reference position when the tip thereof is pointed straight down towards the ground.

7. The automatic welding method as claimed in claim 1, wherein the short circuiting arc transfer comprises the following step:
electrifying the welding torch with a current to heat the tip of the welding torch to cause a discharging of arc, such that droplets are generated during forward movement of the welding torch based on a rule of wire-feeding movement;
wherein a short circuit occurs at the tip of the welding torch and the arc disappears once the droplets contact a weld location of the metal object to be welded, and a tightening effect occurs at the tip of the welding torch, causing the droplets to drop on the weld location of the metal object under reaction of a surface tension generated by a withdrawal movement of the welding torch;
wherein the tip of the welding torch is re-heated to cause the discharging of arc again once the droplets drop from the tip of the welding torch, restarting another round of welding operation.

8. The automatic welding method as claimed in claim 7, wherein the current is 80 to 150 Ampere.
